(19) United States
(12) Patent Application Publication
(10) Pub. No.: US 2017/0127415 A1
(43) Pub. Date: May 4, 2017

(54) COMMUNICATION DEVICE AND COMMUNICATION METHOD THEREOF

(71) Applicant: Institute For Information Industry, Taipei (TW)

(72) Inventor: Chun-Che CHIEN, Taipei City (TW)

(21) Appl. No.: 15/337,134

(22) Filed: Oct. 28, 2016

Related U.S. Application Data
(60) Provisional application No. 62/251,045, filed on Nov. 4, 2015.

(51) Int. Cl. H04W 72/04; H04W 72/12

(52) U.S. Cl. CPC H04W 72/0446; H04W 72/1231; H04W 72/042; H04B 7/2656

(57) ABSTRACT

Communication devices and methods in the present invention adopt frame structures which are different from what conventional communication systems adopt. A frame structure which the present invention adopts includes a plurality of control blocks and a plurality of data blocks, which are distributed among a plurality of channels based on scheduling periods of multiple time spans. Another frame structure which the present invention adopts includes a plurality of frame rows, which correspond to different channels and appear asynchronous in time domain.

### PRIORITY

This application claims priority to U.S. Provisional Patent Application No. 62/251,045 filed on Nov. 4, 2015, which is incorporated herein for reference in its entirety.

### FIELD

The present invention relates to a communication device and a communication method.

### BACKGROUND

In order to avoid collisions within the system or to increase the utilization rate of resources, many communication systems make schedules for different demands, and a commonly adopted solution is the frame structure. However, the frame structure adopted in conventional communication systems still has many problems to be overcome.

As an example, when a base station or a transmitting user terminal is to transmit data to a receiving user terminal (i.e., a single-way transmission application) in a cellular communication system or a D2D communication system, the base station or the transmitting user terminal usually broadcasts control information periodically. By simply monitoring the control information in a specific frame, the receiving user terminal can obtain corresponding data information from the specific frame according to the control information so as to save power consumption of the receiving user terminal. For such an application, the control information and the data information are repeatedly arranged into two blocks adjacent in time at a single fixed scheduling period, i.e., the frame structure presents the sequence of a control block, a data block, a control block, a data block, . . . , and so on along the time axis. However, in such a frame structure, the receiving user terminal has to wait for one scheduling period at most to obtain the necessary data information. Therefore, if the scheduling period is too long, the time necessary for the receiving user terminal to obtain the data information would increase and thus the transmission latency would increase; and if the scheduling period is too short, then available resources would be wasted. For this reason, use of this frame structure is necessarily limited.

On the other hand, when data is to be transmitted between a base station and a receiving user terminal or between a transmitting user terminal and a receiving user terminal (i.e., a two-way transmission application) in the cellular communication system or the D2D communication system, time-division duplex (TDD) or frequency-division duplex (1-DD) may be adopted to define a frame structure in order to improve the transmission efficiency. In a TDD frame structure, there is only one frame row (corresponding to a single channel) and transmission blocks of two opposite directions are distributed in the frame row according to a distribution pattern. In a FDD frame structure, there is usually two frame rows (corresponding to two channels), with transmission blocks of one direction (e.g., downlink blocks) being distributed in one of the frame rows while transmission blocks of the other direction (e.g., uplink blocks) being distributed in the other of the frame rows. In practice, the two frame rows are synchronous in time (i.e., starting points of the two frame rows are aligned with each other).

For the TDD frame structure, there is a transmission latency between transmission blocks of the two opposite directions, and the latency usually remains unchanged unless the frame structure is re-defined or updated (e.g., the distribution pattern is changed). However, in such a frame structure, the two-way transmission efficiency would be degraded if the transmission latency between transmission blocks of the two opposite directions is too long, and available resources would be wasted if the transmission latency is too short. Therefore, use of the TDD frame structure is necessarily limited.

For the FDD frame structure, transmission blocks of the two opposite directions can be arranged in two different channels (i.e., two frame rows) within a same time interval, so transmission latency between transmissions of the two opposite directions can be effectively reduced. However, the transmission latency still exists between two transmissions in a same direction (i.e., between a first transmission and a second transmission of a same device). Importantly, two frame rows being synchronous in time is unfavorable for reducing transmission latency between two transmissions in a same direction in some transmission mechanisms (e.g., in Hybrid Automatic Repeat reQuest (HARQ) or in Scheduling Request).

Accordingly, an objective in the art is to overcome the aforesaid problems confronted by the frame structure adopted in conventional communication system.

### SUMMARY

The disclosure includes a communication device. The communication device may comprise a processor and a transceiver. The processor may be configured to define a frame structure. The frame structure may comprise a plurality of control blocks and a plurality of data blocks, and the control blocks and the data blocks are distributed among a plurality of channels based on scheduling periods of multiple time spans. The transceiver may be configured to perform a communication with a receiving user terminal according to the frame structure.

The disclosure also includes a communication method. The communication method may comprise:

defining a frame structure by a communication device, wherein the frame structure comprises a plurality of control blocks and a plurality of data blocks, and the control blocks and the data blocks are distributed among a plurality of channels based on scheduling periods of multiple time spans; and

performing a communication with a receiving user terminal by the communication device according to the frame structure.

The frame structure adopted in the aforesaid communication apparatus and the communication method has a plurality of channels, and the control blocks and the data blocks are distributed among the channels based on scheduling periods of multiple time spans. Scheduling periods of a longer time span can satisfy the need of receiving user terminals suitable for long transmission latency, and scheduling periods of a shorter time span can satisfy the need of receiving user terminals suitable for low transmission latency, so the communication device and the communication method described above can not only satisfy the needs of receiving user terminals for different transmission latencies, but also reduce waste of available resources. Therefore, as compared with the conventional communication systems, the frame structure adopted in the communication device and the communication method described above is more flexible in use and more efficient.

The disclosure further includes a communication device. The communication device may comprise a processor and a transceiver. The processor may be configured to define a frame structure. The frame structure may comprise a plurality of frame rows, which correspond to different channels and appear asynchronous in the time domain. The transceiver may be configured to perform a communication with a receiving user terminal according to the frame structure.

The disclosure additionally includes a communication method. The communication method may comprise:

defining a frame structure by a communication device, wherein the frame structure may comprise a plurality of frame rows which correspond to different channels and are asynchronous in the time domain; and

performing a communication with a receiving user terminal by the communication device according to the frame structure.

The frame structure adopted in the communication apparatus and the communication method described above has a plurality of frame rows corresponding to different channels, and the frame rows are asynchronous in the time domain. As compared with the conventional TDD frame structure, the frame rows corresponding to different channels can allow transmission blocks of two opposite directions to be arranged in two different channels within a same time interval, so transmission latency between transmissions of the two opposite directions can be effectively reduced (equivalent to the effect of the FDD frame structure). As compared with the FDD frame structure, the frame rows that are asynchronous in the time domain can effectively reduce transmission latency between two transmissions of a same direction in some transmission mechanisms (e.g., HARQ or Scheduling Request). Therefore, as compared with the conventional communication systems, the frame structure adopted in the communication device and the communication method described above is more flexible in use and more efficient.

What described above presents a summary of the present disclosure (including the problem to be solved, the means to solve the problem and the effect of the present invention) to provide a basic understanding of the present invention. However, this is not intended to encompass all aspects of the present invention. Additionally, what described above is neither intended to identify key or essential elements of the present invention, nor intended to define the scope of the present invention. This summary is provided only to present basic concepts of the present invention in a simple form and as an introduction to the following detailed description.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 illustrates a communication system according to one or more embodiments of the present invention;

FIG. 2A illustrates a frame structure adopted in a conventional communication system;

FIG. 2B illustrates a comparison between a frame structure adopted in the communication system illustrated in FIG. 1 and the frame structure illustrated in FIG. 2A;

FIG. 2C illustrates a comparison between another frame structure adopted in the communication system illustrated in FIG. 1 and the frame structure illustrated in FIG. 2A;

FIG. 3 illustrates a communication method according to one or more embodiments of the present invention;

FIG. 4 illustrates a comparison between a frame structure adopted in the communication system illustrated in FIG. 1 and a conventional TDD frame structure;

FIG. 5 illustrates a comparison between a frame structure adopted in the communication system illustrated in FIG. 1 and a conventional FDD frame structure;

FIG. 6 illustrates another comparison between a frame structure adopted in the communication system illustrated in FIG. 1 and a conventional FDD frame structure; and

FIG. 7 illustrates a communication method according to one or more embodiments of the present invention.

### DETAILED DESCRIPTION

One or more example embodiments described hereinafter are not intended to limit the present invention to any specific examples, embodiments, environment, applications, structures, processes or steps described in these embodiments. In the attached drawings, elements unrelated to the present invention are omitted from depiction. In the attached drawings, dimensions of individual elements and dimensional scales among the individual elements are illustrated only as examples, but not to limit the present invention. Unless otherwise stated, like (or similar) reference numerals correspond to like (or similar) elements in the following descriptions.

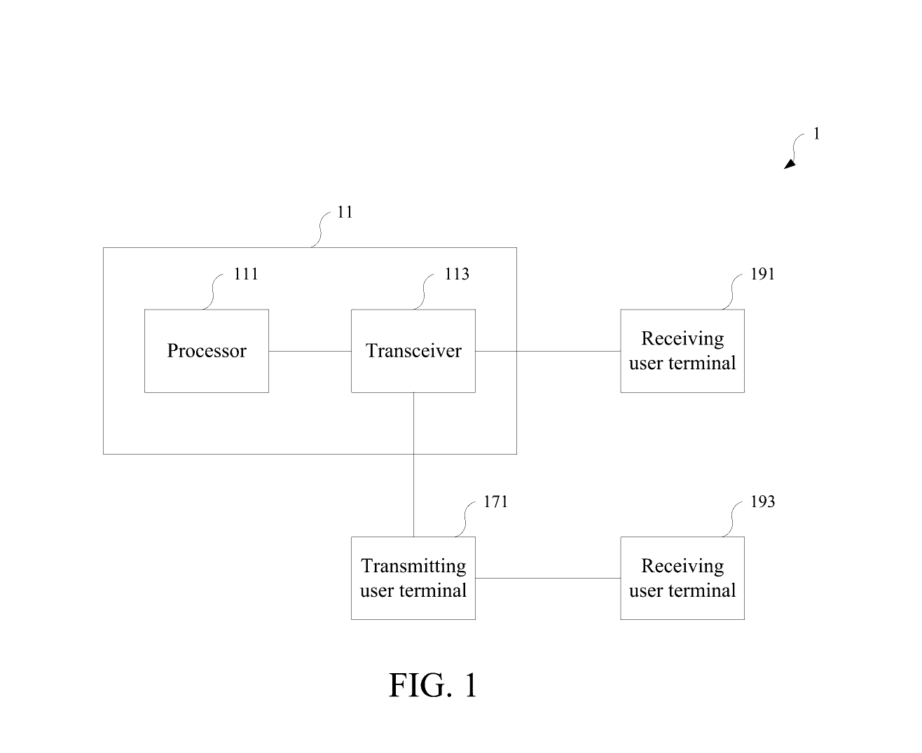

FIG. 1 illustrates a communication system according to one or more embodiments of the present invention. Referring to FIG. 1, a communication system 1 may comprise a communication device 11, a transmitting user terminal 17, a receiving user terminal 191 and a receiving user terminal 193. The communication system 1 may be any of various known communication systems, for example but not limited to, cellular communication systems, D2D communication systems or the like. The communication system 1 may be applicable to various communication standards, for example but not limited to, Long Term Evolution (LTE), LTE-advanced, Universal Mobile Telecommunications System (UMTS), or Global System for Mobile Communications (GSM) or the like.

In some embodiments, the communication device 11 may be a base station, for example but not limited to, a macrocell, a microcell or a picocell. In some embodiments, the communication device 11 may be a transmitting user terminal, for example but not limited to, a tablet computer, a notebook computer, a smartphone or the like.

The communication device 11 may comprise a processor 111 and a transceiver 113. The processor 111 may be electrically connected to the transceiver 113 via some other component (i.e., indirectly electrically connected to the transceiver 113); or the processor 111 may be electrically connected to the transceiver 113 without any component therebetween (i.e., directly electrically connected to the transceiver 113). The processor 111 and the transceiver 113 may communicate information with each other via the direct connection or the indirect connection.

The communication device 11 may comprise a computer device. The computer device may have a computing element for general purpose such as a processor, a microprocessor or the like, and execute various computations by means of the computing element. The computer device may have a memory element for general purpose such as a memory and/or a storage, and store various kinds of data in the memory element. The computer device may have an input/output element for general purpose, and receive data inputted by a user and output data to the user via the input/output element. The computer device may execute corresponding operations via the computing element, the memory element, the input/output element or the like according to a process flow created by software, firmware, a program, an algorithm or the like. The processor 111 may be the computer device or a part of the computer device and is configured to execute the following operations.

The communication device 11 may comprise a transceiving device. The transceiving device may comprise, e.g., an antenna, an amplifier, a modulator, a demodulator, a detector, an analog-to-digital (A/D) converter, a digital-to-analog (D/A) converter or the like. The transceiver 113 may be the transceiving device or a part of the transceiving device, and is configured to execute the following operations, including performing two-way communications with the transmitting user terminal 17, the receiving user terminal 191, the receiving user terminal 193 or other communication devices (not shown).

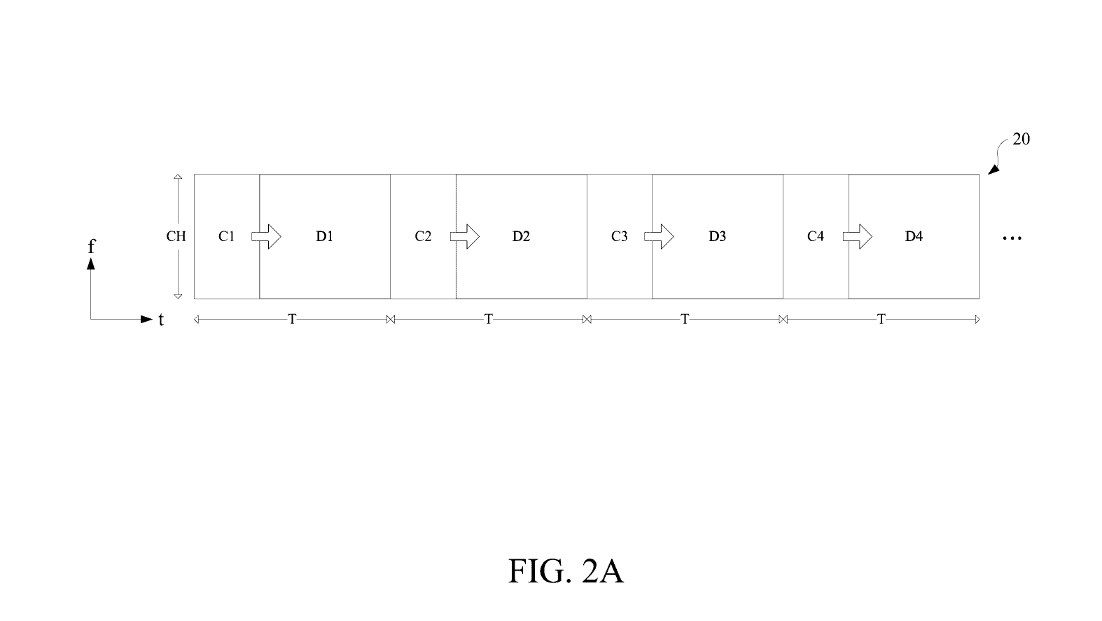

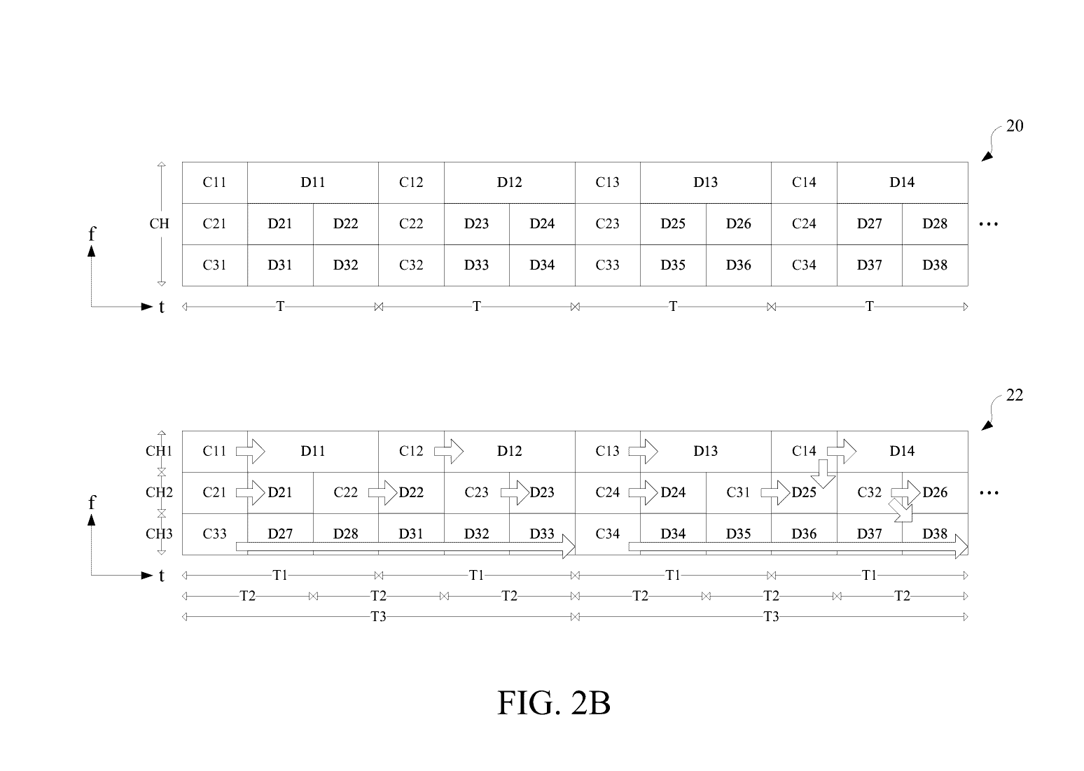

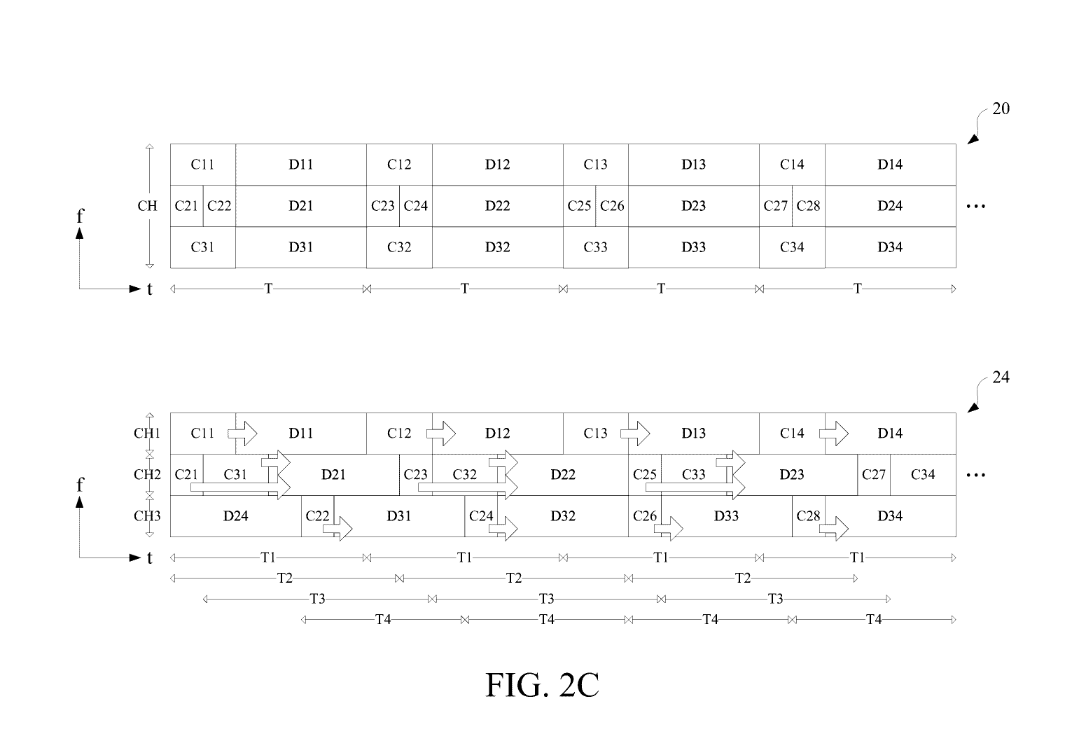

In some embodiments, the processor 111 may be configured to define a frame structure. The frame structure may comprise a plurality of control blocks and a plurality of data blocks, and the control blocks and the data blocks are distributed among a plurality of channels based on scheduling periods of multiple time spans. Then the transceiver 113 may be configured to perform a communication with the receiving user terminal 191 according to the frame structure. Hereinafter, FIGS. 2A to 2C will be taken as an example to describe specific operations of the processor 111 and the transceiver 113 in these embodiments, but this is not intended to limit the present invention. FIG. 2A illustrates a frame structure 20 adopted in a conventional communication system. FIG. 2B illustrates a comparison between a frame structure 22 adopted in the communication system 1 illustrated in FIG. 1 and the frame structure 20 illustrated in FIG. 2A, and FIG. 2C illustrates a comparison between another frame structure 24 adopted in the communication system 1 illustrated in FIG. 1 and the frame structure 20 illustrated in FIG. 2A.

Referring to FIG. 2A, the frame structure 20 adopted in the conventional communication system comprises a plurality of control blocks (i.e., control blocks C1, C2, C3, C4, . . . , and etc.) and a plurality of data blocks (i.e., data blocks D1, D2, D3, D4, . . . , and etc.), where each of the control blocks contains control information and each of the data blocks contains data information. The control information and the data information are repeatedly arranged into two blocks adjacent in time according to a single fixed scheduling period T; that is, in the frame structure 20, control block C1, data block D1, control block C2, data block D2, . . . , and so on exist along the time axis t in this sequence. Additionally, each of the control blocks corresponds to one data block following the control block, e.g., the control block C1 corresponds to the data block D1, the control block C2 corresponds to the data block D2, . . . , and so on. The control block C1 corresponding to the data block D1 means that the control information of the control block C1 comprises a position of the data block D1 in the frame structure 20, and the control block C2 corresponding to the data block D2 means that the control information of the control block C2 comprises a position of the data block D2 in the frame structure 20. As described above, in the frame structure 20, the receiving user terminal has to wait for one scheduling period T at most to obtain the necessary data information. Therefore, if the scheduling period T is too long, the time necessary for the receiving user terminal to obtain the data information would increase and thus the transmission latency would increase; and if the scheduling period T is too short, then available resources would be wasted. For this reason, use of this frame structure 20 is necessarily limited.

Referring to FIG. 2B, the processor 111 may define a frame structure 22 without increasing the amount of resources used by the frame structure 20, and the frame structure 22 can effectively make an improvement on the aforesaid limitation in use of the frame structure 20. The frame structure 22 may comprise a plurality of control blocks and a plurality of data blocks, and the control blocks and the data blocks are distributed among a plurality of channels based on scheduling periods of multiple time spans. For example, the processor 111 may divide the data blocks D1, D2, . . . , and so on comprised in the frame structure 20 on the time axis t, and divide the control blocks C1, C2, . . . , and so on as well as the data blocks D1, D2, . . . , and so on comprised in the frame structure 20 on the frequency axis f, and then interleave the divided data blocks and the divided control blocks in a two dimensional time-frequency space.

As shown in FIG. 2B, the processor 111 may divide the control block C1 of the frame structure 20 into three control blocks C11, C21, C31, divide the control block C2 into three control blocks C12, C22, C32, divide the control block C3 into three control blocks C13, C23, C33, and divide the control block C4 into three control blocks C14, C24, C34. Also, the processor 111 may divide the data block D1 of the frame structure 20 into five data blocks D11, D21, D22, D31, D32, divide the data block D2 of the frame structure 20 into five data blocks D12, D23, D24, D33, D34, divide the data block D3 of the frame structure 20 into five data blocks D13, D25, D26, D35, D36, and divide the data block D4 of the frame structure 20 into five data blocks D14, D27, D28, D37, D38. Then, the processor 111 may interleave the control blocks C11, C21, C31, C12, C22, C32, C13, C23, C33, C14, C24, C34, . . . and so on as well as the data blocks D11, D21, D22, D31, D32, D12, D23, D24, D33, D34, D13, D25, D26, D35, D36, D14, D27, D28, D37, D38, . . . , and so on in the two dimensional time-frequency space to form the frame structure 22 shown in FIG. 2B. In this case, a sum of bandwidths of the channel CH1, the channel CH2 and the channel CH3 in the frame structure 22 is equivalent to the bandwidth of the channel CH in the frame structure 20.

In the frame structure 22, the processor 111 may have each of the control blocks C11, C21, C31, C12, C22, C32, C13, C23, C33, C14, C24, C34, . . . , and so on correspond to at least one (i.e., one or more) of the data blocks D11, D21, D22, D31, D32, D12, D23, D24, D33, D34, D13, D25, D26, D35, D36, D14, D27, D28, D37, D38, . . . , and so on. In this case, control information of one control block corresponding to a plurality of data blocks may comprise positions of the data blocks in the frame structure 22. In the frame structure 22, the processor 111 may also have each of the data blocks D11, D21, D22, D31, D32, D12, D23, D24, D33, D34, D13, D25, D26, D35, D36, D14, D27, D28, D37, D38, . . . , and so on correspond to at least one (i.e., one or more) of the control blocks C11, C21, C31, C12, C22, C32, C13, C23, C33, C14, C24, C34, . . . , and so on. In other words, the processor 111 may have a plurality of control blocks among the control blocks C11, C21, C31, C12, C22, C32, C13, C23, C33, C14, C24, C34, . . . , and so on correspond to a same one of the data blocks D11, D21, D22, D31, D32, D12, D23, D24, D33, D34, D13, D25, D26, D35, D36, D14, D27, D28, D37, D38, . . . , and so on. In this case, control information of the plurality of control blocks corresponding to a same data block may all comprise the position of the same data block in the frame structure 22.

In the frame structure 22, the processor 111 may have at least one control block among the control blocks CH, C21, C31, C12, C22, C32, C13, C23, C33, C14, C24, C34, . . . , and so on that is distributed in one of the channels CH-CH3 correspond to at least one data block among the data blocks D11, D21, D22, D31, D32, D12, D23, D24, D33, D34, D13, D25, D26, D35, D36, D14, D27, D28, D37, D38, . . . , and so on that is distributed in another of the channels CH1-CH3. In other words, control blocks and data blocks of different channels may also correspond to each other.

For example, as shown in FIG. 2B, control blocks CH, C12 and C13 in the channel CH1 may correspond to data blocks D11, D12 and D13 in the channel CH1 respectively, control block C14 in the channel CH1 may correspond to data block D14 in the channel CH1 and data block D25 in the channel CH2 at the same time, control blocks C21, C22, C23, C24 and C31 in the channel CH2 may correspond to data blocks D21, D22, D23, D24 and D25 in the channel CH2 respectively, control block C32 in the channel CH2 may correspond to data block D26 in the channel CH2 and data block D38 in the channel CH3 at the same time, control block C33 in the channel CH3 may correspond to data blocks D27, D28, D31, D32 and D33 in the channel CH3 at the same time, and control block C34 in the channel CH3 may correspond to data blocks D34, D35, D36, D37 and D38 in the channel CH3 at the same time.

Unlike the frame structure 20 which provides only a single fixed scheduling period T, the frame structure 22 provides three scheduling periods of different time spans, namely, a scheduling period T2 of the shortest time span, a scheduling period T1 of the second shortest time span, and a scheduling period T3 of the longest time span. Then, each receiving user terminal 191 may choose an appropriate scheduling period from the scheduling periods T1-T3 provided by the frame structure 22 depending on its own transmission latency requirement to perform a communication with the communication device 11 (including communication behaviors such as monitoring the control information of the control blocks and obtaining data information from the data blocks). Because of the scheduling periods T1-T3 provided by the frame structure 22, the communication device 11 not only can satisfy the different transmission latency requirements of the receiving user terminals 191, but also will not waste available resources. In other words, as compared with the frame structure 20, the frame structure 22 is more flexible in use and more efficient, so it can effectively make an improvement on the aforesaid limitations in use of the frame structure 20.

Referring to FIG. 2B, control blocks CH, C12, C13, C14, . . . , and so on as well as data blocks D11, D12, D13, D14, . . . , and so on that form the scheduling period T1 are all distributed in the channel CH1, control blocks C21, C22, C23, C24, C31, C32, . . . , and so on as well as data blocks D21, D22, D23, D24, D25, D26, . . . , and so on that form the scheduling period T2 are all distributed in the channel CH2, and control blocks C33, C34, . . . , and so on as well as data blocks D27, D28, D31, D32, D33, D34, D35, D36, D37, D38, . . . , and so on are all distributed in the channel CH3 in the frame structure 22. Therefore, in case that a certain channel fails to operate normally, all control blocks in this channel will become invalid.

To mitigate the aforesaid effects, the control blocks may be arbitrarily interleaved between the channels CH1-CH3 in some embodiments. For example, the control block C11 in the channel CH1 may be swapped with the control block C21 in the channel CH2, and the control block C13 in the channel CH1 may be swapped with the control block C24 in the channel CH2. In this case, the control block C11 in the channel CH2 still corresponds to the data block D11 in the channel CH1, and the control block C13 in the channel CH2 still corresponds to the data block D13 in the channel CH1. After such interleaving, three scheduling periods T1-T3 of different time spans are still provided by the frame structure 22, and even when the channel CH1 or the channel CH2 fails to operate normally, the control blocks CH, C12, C13, C14, . . . , and so on that form the scheduling period T1 or the control blocks C21, C22, C23, C24, C31, C32, . . . , and so on that form the scheduling period T2 will not all become invalid.

In some embodiments, as shown in FIG. 2C, the processor 111 may define another frame structure 24 without increasing the amount of resources used by the frame structure 20, and the frame structure 24 can effectively make an improvement on the aforesaid limitations in use of the frame structure 20. The frame structure 24 may comprise a plurality of control blocks and a plurality of data blocks, and the control blocks and the data blocks are distributed among a plurality of channels based on scheduling periods of multiple time spans. For example, the processor 111 may divide the control blocks C1, C2, . . . , and so on comprised in the frame structure 20 on the time axis t and divide the control blocks C1, C2, . . . , and so on as well on the data blocks D1, D2, . . . , and so on comprised in the frame structure 20 on the frequency axis f, and then interleave the divided data blocks and the divided control blocks in the two-dimensional time-frequency space. Unlike the frame structure 22 where the data blocks D1, D2, . . . , and so on comprised in the frame structure 20 are divided on the time axis t, the frame structure 24 divides the control blocks C1, C2, . . . , and so on comprised in the frame structure 20 on the time axis.

For example, as shown in FIG. 2C, the processor 111 may divide the control block C1 of the frame structure 20 into four control blocks C11, C21, C22, C31, divide the control block C2 into four control blocks C12, C23, C24, C32, divide the control block C3 into four control blocks C13, C25, C26, C33, and divide the control block C4 into four control blocks C14, C27, C28, C34. Also, the processor 111 may divide the data block D1 of the frame structure 20 into three data blocks D11, D21, D31, divide the data block D2 of the frame structure 20 into three data blocks D12, D22, D32, divide the data block D3 of the frame structure 20 into three data blocks D13, D23, D33, and divide the data block D4 of the frame structure 20 into three data blocks D14, D24, D34. Then, the processor 111 may interleave the control blocks C11, C21, C22, C31, C12, C23, C24, C32, C13, C25, C26, C33, C14, C27, C28, C34, . . . and so on as well as the data blocks D11, D21, D31, D12, D22, D32, D13, D23, D33, D14, D24, D34, . . . , and so on in the two dimensional time-frequency space to form the frame structure 24 shown in FIG. 2C. In this case, a sum of bandwidths of the channel CH1, the channel CH2 and the channel CH3 in the frame structure 24 is equivalent to the bandwidth of the channel CH in the frame structure 20.

In the frame structure 24, the processor 111 may have each of the control blocks C11, C21, C22, C31, C12, C23, C24, C32, C13, C25, C26, C33, C14, C27, C28, C34, . . . , and so on correspond to at least one (i.e., one or more) of the data blocks D11, D21, D31, D12, D22, D32, D13, D23, D33, D14, D24, D34, . . . , and so on. In the frame structure 24, the processor 111 may also have each of the data blocks D11, D21, D31, D12, D22, D32, D13, D23, D33, D14, D24, D34, . . . , and so on correspond to at least one (i.e., one or more) of the control blocks CH, C21, C22, C31, C12, C23, C24, C32, C13, C25, C26, C33, C14, C27, C28, C34, . . . , and so on. In the frame structure 24, control blocks and data blocks of different channels may also correspond to each other.

As shown in FIG. 2C, control blocks C11, C12, C13 and C14 in the channel CH1 may correspond to data blocks D11, D12, D13 and D14 in the channel CH1 respectively, control blocks C21 and C31 in the channel CH2 may correspond to data block D21 in the channel CH2 at the same time, control blocks C23 and C32 in the channel CH2 may correspond to data block D22 in the channel CH2 at the same time, control blocks C25 and C33 in the channel CH2 may correspond to data block D23 in the channel CH2 at the same time, and control blocks C22, C24, C26, C28 in the channel CH3 may correspond to data blocks D31, D32, D33, D34 in the channel CH3 respectively.

Unlike the frame structure 20 which provides only a single fixed scheduling period T, the frame structure 24 provides four scheduling periods of different time spans, namely, a scheduling period T4 of the shortest time span, a scheduling period T1 of the second shortest time span, and scheduling periods T2 and T3 of the longest time span. The scheduling periods T2 and T3 having the same time span may provide different control information to satisfy different needs. Then, each receiving user terminal 191 may choose an appropriate scheduling period from the scheduling periods T1-T4 provided by the frame structure 24 depending on its own transmission latency requirement to perform a communication with the communication device 11 (including communication behaviors such as monitoring the control information of the control blocks and obtaining data information from the data blocks). Because of the scheduling periods T1-T4 provided by the frame structure 24, the communication device 11 not only can satisfy the different transmission latency requirements of the receiving user terminals 191, but also will not waste available resources. In other words, as compared with the frame structure 20, the frame structure 24 is more flexible in use and more efficient, so it can effectively make an improvement on the aforesaid limitations in use of the frame structure 20.

The frame structure 22 shown in FIG. 2B and the frame structure 24 shown in FIG. 24 are not intended to limit the present invention. In principal, within the scope of the spirit of the present invention, the processor 111 may arbitrarily divide the control blocks C1, C2, . . . , and so on and/or the data blocks D1, D2, . . . , and so on on the time axis t and/or the frequency axis f and then arbitrarily interleave the divided data blocks and the divided control blocks in the two-dimensional time-frequency space to define a frame structure having scheduling periods of multiple time spans depending on different needs. Further, within the scope of the spirit of the present invention, the processor 111 may have the control blocks correspond to the data blocks arbitrarily in the defined frame structure to satisfy different needs.

In some embodiments, the processor 111 may define the frame structure (e.g., the frame structure 22 or 24) having scheduling periods of multiple time spans according to Quality of Service (QoS) information provided by the receiving user terminal 191. For example, the processor 111 may decide how to divide the control blocks C1, C2, . . . , and so on and/or the data blocks D1, D2, . . . , and so on and how to interleave the divided data blocks and the divided control blocks in the two-dimensional time-frequency space according to the transmission latency requirements provided by the user receiving user terminal 191, the channel conditions or the like.

In some embodiments, the communication device 11 may be a transmitting user terminal, and is configured to perform a sidelink communication (e.g., D2D communication) with the receiving user terminal 191. In this case, each control block comprised in the frame structure 22 or 24 may be a scheduling assignment pool, and each data block comprised therein may be a data pool.

In some embodiments, the communication device 11 may be a base station, and is configured to perform a downlink communication with the receiving user terminal 191. In this case, each control block comprised in the frame structure 22 or 24 may be a physical downlink control channel (PDCCH), and each data block comprised in the frame structure 22 or 24 may be a physical downlink shared channel (PDSCH). In some embodiments, the communication device 11 may be a base station, and is configured to perform an uplink communication with the receiving user terminal 191. In this case, each control block comprised in the frame structure 22 or 24 may be a physical downlink control channel (PDCCH), and each data block comprised in the frame structure 22 or 24 may be a physical uplink shared channel (PUSCH).

In some embodiments, the communication device 11 may be a base station, and is configured to perform a sidelink communication with the receiving user terminal 193. In this case, the processor 111 may define another frame structure, and the another frame structure comprises a plurality of scheduling assignment pools and a plurality of data pools, the scheduling assignment pools and the data pools are distributed among a plurality of channels based on scheduling periods of multiple time spans. Further, the transceiver 113 may transmit the another frame structure to the transmitting user terminal 17 so that the transmitting user terminal 17 performs the sidelink communication with the receiving user terminal 193 according to the another frame structure. In this case, the processor 111 may define the another frame structure according to resource availability information provided by the transmitting user terminal 17 and QoS information provided by the receiving user terminal 193.

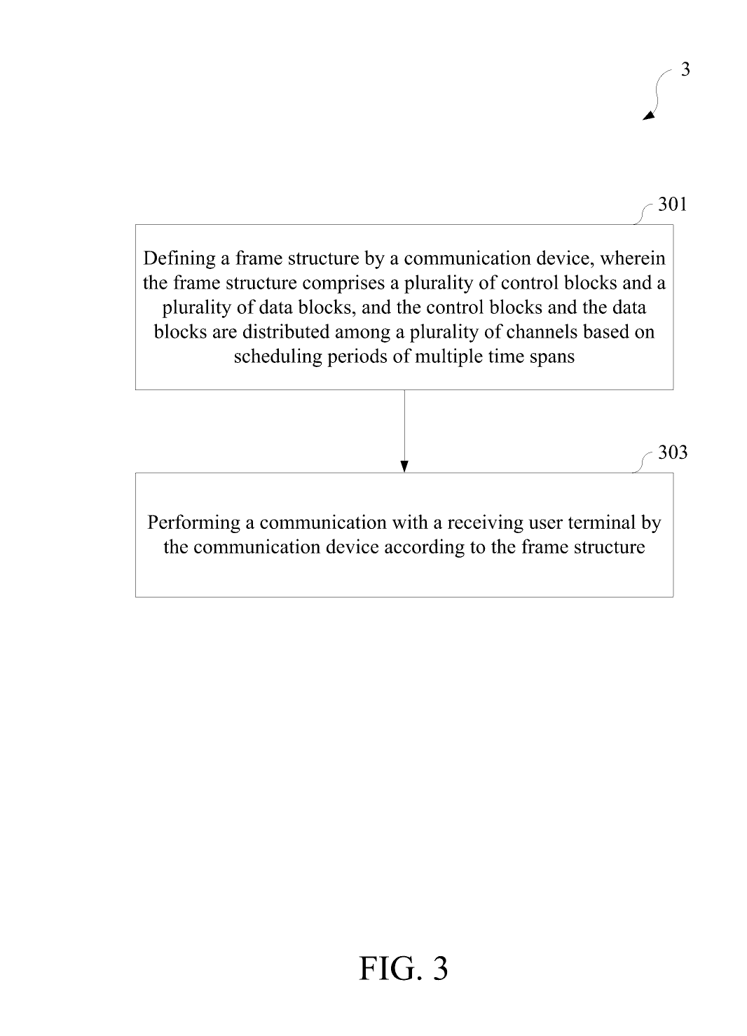

FIG. 3 illustrates a communication method according to one or more embodiments of the present invention. Referring to FIG. 3, the communication method 3 may comprise the following steps of: defining a frame structure by a communication device, wherein the frame structure comprises a plurality of control blocks and a plurality of data blocks, and the control blocks and the data blocks are distributed among a plurality of channels based on scheduling periods of multiple time spans (labeled as 301); and performing a communication with a receiving user terminal by the communication device according to the frame structure (labeled as 303).

In some embodiments, each of the control blocks may correspond to at least one of the data blocks.

In some embodiments, each of the data blocks may correspond to at least one of the control blocks.

In some embodiments, at least one control block among the control blocks that is distributed in one of the channels may correspond to at least one data block among the data blocks that is distributed in another of the channels.

In some embodiments, the communication device may define the frame structure according to QoS information provided by the receiving user terminal.

In some embodiments, the communication device may be a transmitting user terminal, each of the control blocks may be a scheduling assignment pool, each of the data blocks may be a data pool, and the communication may be a sidelink communication.

In some embodiments, the communication device may be a base station, each of the control blocks may be a physical downlink control channel (PDCCH), each of the data blocks may be a physical downlink shared channel (PDSCH), and the communication may be a downlink communication. In some embodiments, the communication device may be a base station, each of the control blocks may be a PDCCH, each of the data blocks may be a physical uplink shared channel (PUSCH), and the communication may be an uplink communication.

In some embodiments, the communication device may be a base station, and the communication method 3 may further comprise the following step of: defining another frame structure by the communication device, wherein the another frame structure comprises a plurality of scheduling assignment pools and a plurality of data pools, the scheduling assignment pools and the data pools are distributed among a plurality of channels based on scheduling periods of multiple time spans; and transmitting the another frame structure to a transmitting user terminal by the communication device so that the transmitting user terminal performs a sidelink communication with another receiving user terminal according to the another frame structure.

In some embodiments, the communication device may be a base station, and the communication method 3 may further comprise the following step of: defining another frame structure by the communication device, wherein the another frame structure comprises a plurality of scheduling assignment pools and a plurality of data pools, the scheduling assignment pools and the data pools are distributed among a plurality of channels based on scheduling periods of multiple time spans; and transmitting the another frame structure to a transmitting user terminal by the communication device so that the transmitting user terminal performs a sidelink communication with another receiving user terminal according to the another frame structure. Further, the communication device may define the another frame structure according to resource availability information provided by the transmitting user terminal and QoS information provided by the another receiving user terminal.

The communication method 3 may be applied to the communication device 11 to accomplish various operations of the communication device 11. Because corresponding steps of the communication method 3 to accomplish these operations can be straightforwardly known by those of ordinary skill in the art from the above description of the communication device 11, they will not be further described herein.

The frame structure adopted in the communication apparatus and the communication method described above has a plurality of channels, and the control blocks and the data blocks are distributed among the channels based on scheduling periods of multiple time spans. Scheduling periods of a longer time span can satisfy the need of receiving user terminals suitable for long transmission latency, and scheduling periods of a shorter time span can satisfy the need of receiving user terminals suitable for low transmission latency, so the communication device and the communication method described above can not only satisfy the needs of receiving user terminals having different transmission latency requirements, but also reduce waste of available resources. Therefore, as compared with the conventional communication systems, the frame structure adopted in the communication device and the communication method described above is more flexible in use and more efficient.

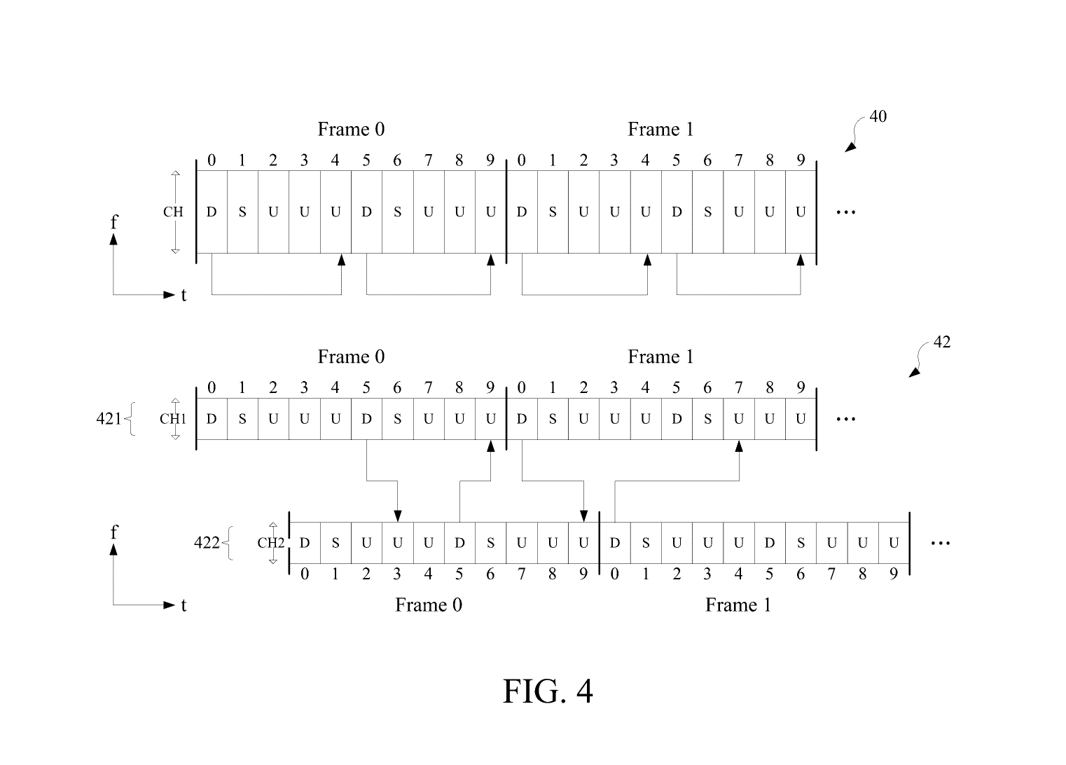

Hereinafter, FIG. 4 will be taken as an example to describe how the present invention overcomes the limitation in use of the conventional TDD frame structure, but this is not intended to limit the present invention. FIG. 4 illustrates a comparison between a frame structure adopted in the communication system illustrated in FIG. 1 and a conventional TDD frame structure. In FIG. 4, the TDD frame structure 40 is created in a HARQ communication mechanism. In the HARQ communication mechanism, a communication device (e.g., a base station or a transmitting user terminal) which has transmitted a signal to another communication device (e.g., a receiving user terminal) can determine whether to retransmit this signal according to an acknowledgement/non-acknowledgement (ACK/NACK) fed back by the other communication device. For convenience of description, a HARQ between a base station and a receiving user terminal will be taken as an example, but this is not intended to limit the present invention.

Referring to FIG. 4, because time-division duplex (TDD) is adopted, the frame structure 40 comprises only a single frame row (i.e., only a single channel CH is used). In the channel CH, the frame structure 40 comprises a plurality of frames, i.e., frame 0, frame 1, frame 2, . . . , and so on. Each frame comprises ten subframes, i.e., subframe 0, subframe 1, subframe 2, . . . , subframe 9. The subframe labeled as D is dedicated for downlink communications (i.e., for use by a conventional base station to transmit signals to a conventional receiving user terminal), the subframe labeled as U is dedicated for uplink communications (i.e., for use by the conventional receiving user terminal to transmit ACK/NACK signals to the conventional base station), and the subframe labeled as S connects between downlink communications and uplink communications and comprises a guard period for buffering between the downlink communications and the uplink communications. In other words, D represents downlink blocks, U represents uplink blocks, and S represents special blocks.

As shown in FIG. 4, the frame structure 40 has a distribution pattern adapted to distribute subframes of different functions on the time axis t, e.g., the subframes 0-9 may correspond to D, S, U, U, U, D, S, U, U, U respectively. Each subframe labeled as D corresponds to a subframe labeled as U (as shown by the arrows), and a distance between each two of corresponding subframe D and subframe U corresponding to each other is just the transmission latency between the downlink communication and the uplink communication. As described above, in the frame structure 40, the two-way transmission efficiency would be degraded if the distance (i.e., the transmission latency) between the two corresponding subframe D and subframe U is too long, and available resources would be wasted if the distance is too short. Therefore, use of the frame structure 40 is necessarily limited.

Referring to FIG. 4, the processor 111 may define a frame structure 42 without increasing the amount of resources used by the frame structure 40, and the frame structure 42 can effectively make an improvement on the aforesaid limitation in use of the frame structure 40. In detail, the frame structure 42 may comprise a plurality of frame rows, which correspond to different channels and appear asynchronous in the time domain. For example, the processor 111 may divide the frame structure into a plurality of frame rows on the frequency axis f and then shift these frame rows on the time axis t in such a way that the frame rows become asynchronous in the time domains (e.g., starting points of the frame rows become unaligned with each other).

As shown in FIG. 4, the processor 111 may divide the frame structure 40 into a plurality of frame rows (e.g., frame rows 421 and frame rows 422) on the frequency axis f and then shift the frame rows 421 and 422 on the time axis t to form the frame structure 42 as shown in FIG. 4. In this case, a sum of bandwidths of the channel CH1 and the channel CH2 in the frame structure 42 may be equal to the bandwidth of the channel CH in the frame structure 40. The frame row 421 and the frame row 422 may have a same distribution pattern (e.g., a distribution pattern identical to that of the frame structure 40) which comprises a plurality of downlink blocks (i.e., subframes labeled as D) and a plurality of uplink blocks (i.e., subframes labeled as U).

Any of the downlink blocks (i.e., subframes labeled as D) and uplink blocks (i.e., subframes labeled as U) comprised in one of the frame rows 421 and 422 may correspond to any of uplink blocks (i.e., subframes labeled as U) and the downlink blocks (i.e., subframes labeled as D) comprised in the other of the frame rows 421 and 422 respectively. For example, the processor 111 may have a subframe 5 of the frame 0 in the frame row 421 correspond to a subframe 3 of the frame 0 of the frame row 422, have a subframe 5 of the frame 0 in the frame row 422 correspond to a subframe 9 of the frame 0 of the frame row 421, have a subframe 0 of the frame 1 in the frame row 421 correspond to a subframe 9 of the frame 0 of the frame row 422, and have a subframe 0 of the frame 1 in the frame row 422 correspond to a subframe 7 of the frame 1 of the frame row 421.

As shown in FIG. 4, unlike the frame structure 40 which can only satisfy the need for a single transmission latency, the frame structure 42 can satisfy the need for multiple transmission latencies. Thus, each receiving user terminal 191 may choose an appropriate downlink block and an appropriate uplink block depending on its own transmission latency requirement to perform a communication with the communication device 11 (including communication behaviors such as transmitting signals from the communication device 11 to the receiving user terminal 191 and transmitting ACK/NACK signal from the receiving user terminal 191 back to the communication device 11). In this way, the communication device 11 not only can satisfy the different transmission latency requirements of the receiving user terminals 191, but also will not waste available resources. In other words, as compared with the frame structure 40, the frame structure 42 is more flexible in use and more efficient, so it can effectively make an improvement on the aforesaid limitations in use of the frame structure 40.

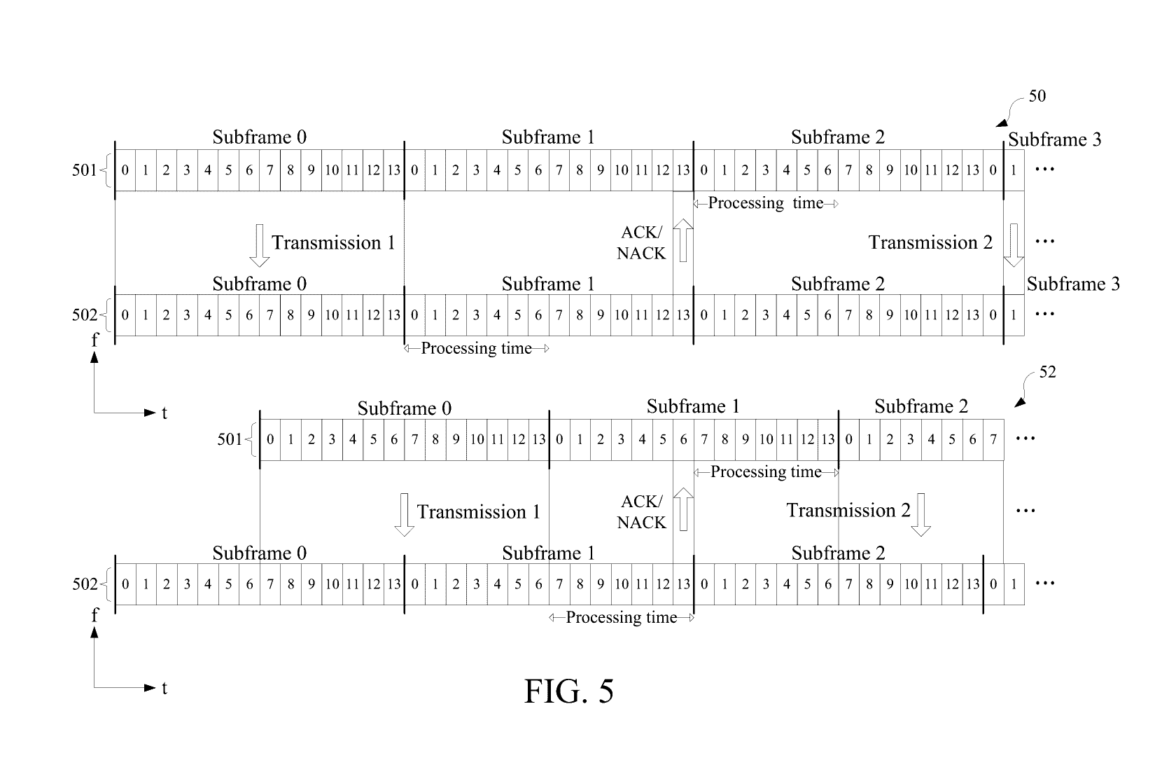

Hereinafter, FIG. 5 will be taken as an example to describe how the present invention overcomes the limitation in use of the conventional FDD frame structure, but this is not intended to limit the present invention. FIG. 5 illustrates a comparison between a frame structure adopted in the communication system illustrated in FIG. 1 and a conventional FDD frame structure. In FIG. 5, the FDD frame structure 50 is created in a HARQ communication mechanism. For convenience of description, a HARQ between a base station and a receiving user terminal will be taken as an example, but this is not intended to limit the present invention.

Referring to FIG. 5, because frequency-division duplex (TDD) is adopted, the frame structure 50 comprises two frame rows, i.e., a frame row 501 and a frame row 502 corresponding to different channels respectively. The frame row 501 and the frame row 502 each comprise a plurality of frames, namely, a frame 0, a frame 1, a frame 2, . . . , and so on; each of the frames comprises ten subframes, namely, a subframe 0, a subframe 1, a subframe 2, . . . , and a subframe 9; and each of the subframes comprises fourteen symbol times, namely, a symbol time 0, a symbol time 1, . . . , and a symbol time 13. Transmission blocks of one direction (e.g., downlink blocks) are distributed in one of the frame rows 501 and 502 while transmission blocks of the other direction (e.g., uplink blocks) are distributed in the other of the frame rows 501 and 502. In other words, one of the frame rows 501 and 502 is dedicated for downlink transmission while the other is dedicated for uplink transmission. For convenience of description, a case where the frame row 501 is used for downlink transmission and the frame row 502 is used for uplink transmission will be taken as an example hereinafter, but this is not intended to limit the present invention.

As shown in FIG. 5, the frame row 501 and the frame row 502 in the frame structure 50 are synchronous in the time domain, i.e., starting points of the frame row 501 and the frame row 502 are aligned with each other in the time domain. In this case, assuming that a conventional base station begins to transmit a signal having a time span of one subframe to a conventional receiving user terminal (i.e., Transmission 1) from the symbol time 0 of the subframe 0 of the frame row 501, then the conventional receiving user terminal will complete receiving of the signal at the symbol time 13 of the subframe 0 of the frame row 502, and experience a processing period (e.g., which lasts for seven symbol times) in the subframe 1 of the frame row 502, and then transmit an ACK/NACK signal to the base station during the last symbol time (i.e., the symbol time 13) of the subframe 1 of the frame row 502. After receiving the ACK/NACK signal, the conventional base station experiences a processing period (e.g., which lasts for seven symbol times) in the subframe 2 of the frame row 501, and then must wait until arrival of the next subframe (i.e., the symbol time 0 of the subframe 3) before it can re-transmit the signal to the conventional receiving user terminal (i.e., Transmission 2). Therefore, the round trip time (RTT) is about three subframes in the frame structure 50, i.e., the time duration from the first signal transmission to the second signal transmission of the conventional base station is about three subframes.

Also as shown in FIG. 5, the frame row 501 and the frame row 502 in the frame structure 52 are asynchronous in the time domain, that is, starting points of the frame row 501 and the frame row 502 are not aligned with each other in the time domain. For example, the frame rows 501 and 502 are shifted through a timing advance mechanism to present the asynchronous state in the time domain. In this case, assuming that the communication device 11 begins to transmit a signal having a time span of one subframe to the receiving user terminal 191 (i.e., Transmission 1) from the symbol time 0 of the subframe 0 of the frame row 501, then the receiving user terminal 191 will complete receiving of the signal in the symbol time 6 of the subframe 1 of the frame row 502, and experience a processing period (e.g., which lasts for seven symbol times) in the subframe 1 of the frame row 502, and then transmit an ACK/NACK signal to the communication device 11 during the last symbol time (i.e., the symbol time 13) of the subframe 1 of the frame row 502. After receiving the ACK/NACK signal, the communication device 11 experiences a processing period (e.g., which lasts for seven symbol times) in the subframe 1 of the frame row 501, and then must wait until arrival of the next subframe (i.e., the symbol time 0 of the subframe 2) before it can re-transmit the signal to the receiving user terminal 191 (i.e., Transmission 2). Therefore, the round trip time (RTT) is about two subframes in the frame structure 52, i.e., the time duration from the first signal transmission to the second signal transmission of the conventional base station is about two subframes.

As can be known from FIG. 5, the frame structure 52 can effectively reduce the RTT (i.e., advance the re-transmission time) as compared with the frame structure 50, so it is favorable for reducing transmission latency between two transmissions of a same direction.

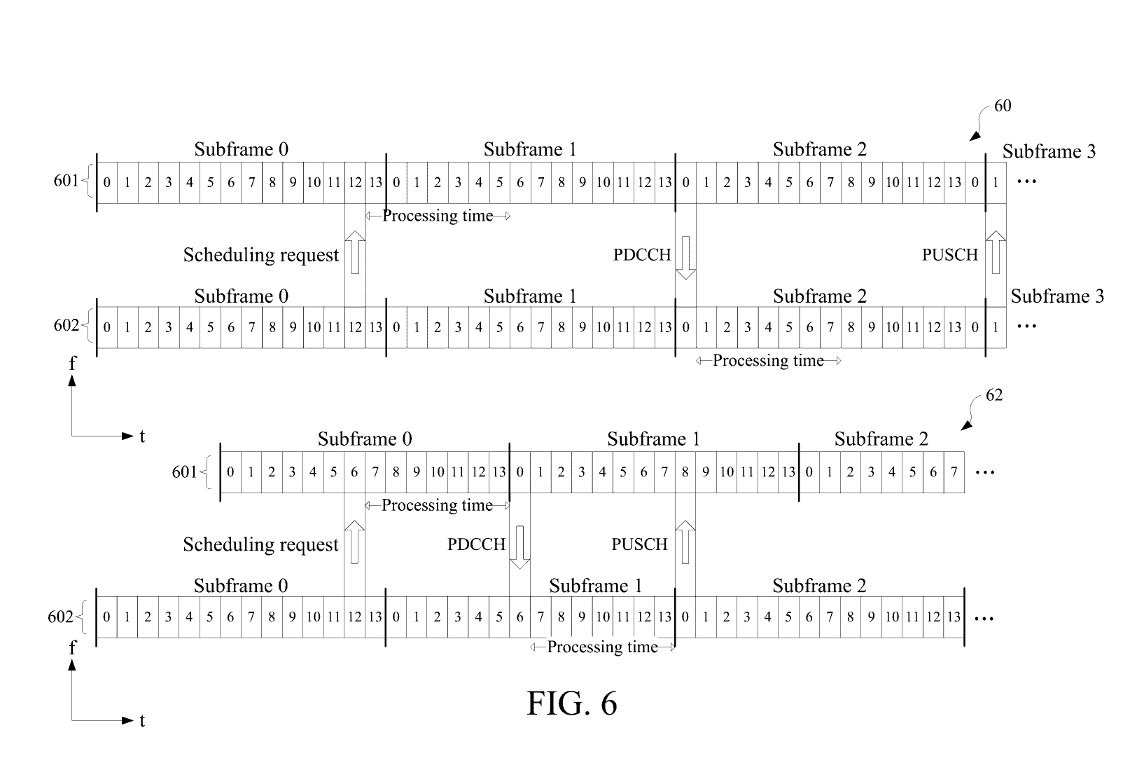

Hereinafter, FIG. 6 will be taken as an example to describe how the present invention overcomes the limitation in use of the conventional FDD frame structure, but this is not intended to limit the present invention. FIG. 6 illustrates another comparison between a frame structure adopted in the communication system illustrated in FIG. 1 and a conventional FDD frame structure. In FIG. 6, the FDD frame structure 60 is created in a scheduling request communication mechanism. For convenience of description, a scheduling request between a base station and a receiving user terminal will be taken as an example, but this is not intended to limit the present invention.

Referring to FIG. 6, just like the frame structure 50, the frame structure 60 also comprises two frame rows, i.e., a frame row 601 and a frame row 602 corresponding to different channels respectively. The frame row 601 and the frame row 602 each comprise a plurality of frames, namely, a frame 0, a frame 1, a frame 2, . . . , and so on; each of the frames comprises ten subframes, namely, a subframe 0, a subframe 1, a subframe 2, . . . , and a subframe 9; and each of the subframes comprises fourteen symbol times, namely, a symbol time 0, a symbol time 1, . . . , and a symbol time 13. Transmission blocks of one direction (e.g., downlink blocks) are distributed in one of the frame rows 601 and 602 while transmission blocks of the other direction (e.g., uplink blocks) are distributed in the other of the frame rows 601 and 602. In other words, one of the frame rows 601 and 602 is dedicated for downlink transmission while the other is dedicated for uplink transmission. For convenience of description, a case where the frame row 601 is used for downlink transmission and the frame row 602 is used for uplink transmission will be taken as an example hereinafter, but this is not intended to limit the present invention.

As shown in FIG. 6, the frame row 601 and the frame row 602 in the frame structure 60 are synchronous in the time domain, i.e., starting points of the frame row 601 and the frame row 602 are aligned with each other in the time domain. In this case, assuming that a conventional receiving user terminal transmits a scheduling request to a conventional base station at the symbol time 12 of the subframe 0 of the frame row 602, then the conventional base station having received the scheduling request will experience a processing period (e.g., which lasts for seven symbol times) and then must wait until arrival of the next subframe (i.e., the symbol time 0 of the subframe 2 of the frame row 601) before it can transmit a physical downlink control channel PDCCH to the conventional receiving user terminal. The conventional receiving user terminal having received the physical downlink control channel PDCCH will experience a processing period (e.g., which lasts for seven symbol times) and then must wait until arrival of the next subframe (i.e., the symbol time 0 of the subframe 3 of the frame row 602) before it can transmit a physical uplink shared channel PUSCH to the conventional base station. Therefore, in the frame structure 60, the time from the first signal transmission (i.e., transmission of the scheduling request) to the second signal transmission (i.e., transmission of the physical uplink shared channel PUSCH) is about twenty-five subframes.

Also as shown in FIG. 6, the frame row 601 and the frame row 602 in the frame structure 62 are asynchronous in the time domain, that is, starting points of the frame row 601 and the frame row 602 are not aligned with each other in the time domain. For example, the frame rows 601 and 602 are shifted through a timing advance mechanism to present the asynchronous state in the time domain. In this case, assuming that the receiving user terminal 191 transmits a scheduling request to the communication device 11 at the symbol time 12 of the subframe 0 of the frame row 602, then the communication device 11 having received the scheduling request will experience a processing period (e.g., which lasts for seven symbol times) and then must wait until arrival of the next subframe (i.e., the symbol time 0 of the subframe 1 of the frame row 601) before it can transmit a physical downlink control channel PDCCH to the receiving user terminal 191. The receiving user terminal 191 having received the physical downlink control channel PDCCH will experience a processing period (e.g., which lasts for seven symbol times) and then must wait until arrival of the next subframe (i.e., the symbol time 0 of the subframe 2 of the frame row 602) before it can transmit a physical uplink shared channel PUSCH to the communication device 11. Therefore, in the frame structure 62, the time from the first signal transmission (i.e., transmission of the scheduling request) to the second signal transmission (i.e., transmission of the physical uplink shared channel PUSCH) is about fifteen subframes.

As can be known from FIG. 6, the frame structure 62 can effectively reduce the time between transmission of the scheduling request and transmission of the physical uplink shared channel PUSCH as compared with the frame structure 60, so it is favorable for reducing transmission latency between two transmissions of a same direction.

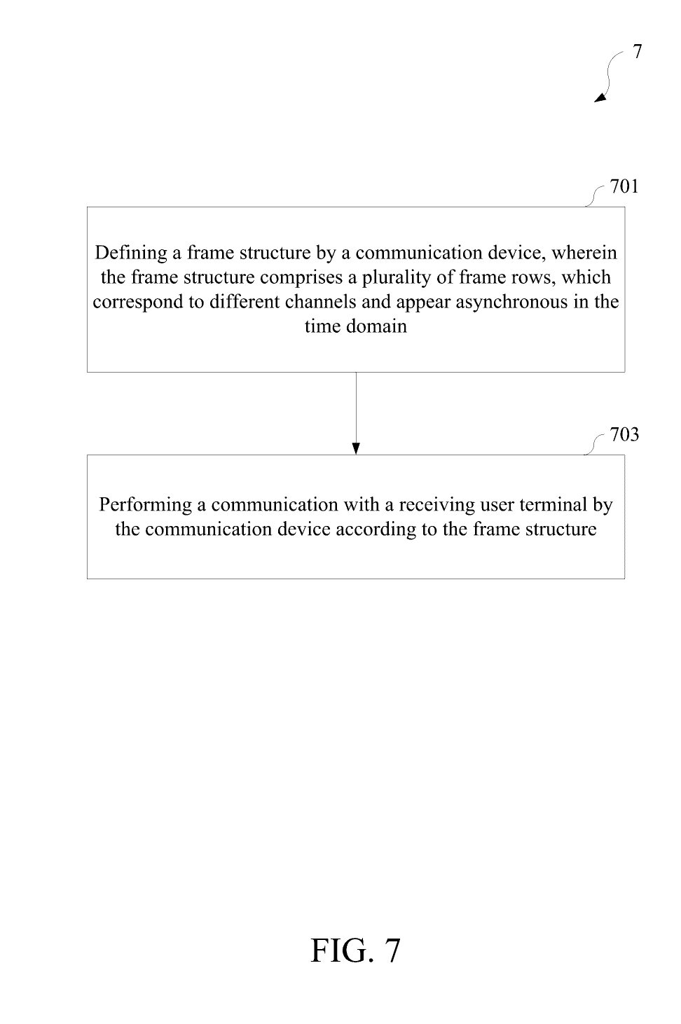

FIG. 7 illustrates a communication method according to one or more embodiments of the present invention. Referring to FIG. 7, the communication method 7 may comprise the following steps: defining a frame structure by a communication device, wherein the frame structure comprises a plurality of frame rows, which correspond to different channels and appear asynchronous in the time domain (labeled as 701); and performing a communication with a receiving user terminal by the communication device according to the frame structure (labeled as 703).

In some embodiments, the frame rows have a same distribution pattern which comprises a plurality of downlink blocks and a plurality of uplink blocks, any of the downlink blocks comprised in each of the frame rows corresponds to any of the uplink blocks comprised in another of the frame rows, and any of the uplink blocks comprised in each of the frame rows corresponds to any of the downlink blocks comprised in another of the frame rows.

In some embodiments, the frame rows include a first frame row and a second frame row, the first frame row comprises a plurality of downlink blocks and the second frame row comprises a plurality of uplink blocks.

The communication method 7 may be applied to the communication device 11 to accomplish various operations of the communication device 11. Because corresponding steps of the communication method 7 to accomplish these operations can be straightforwardly known by those of ordinary skill in the art from the above description of the communication device 11, they will not be further described herein.

The frame structure adopted in the communication apparatus and the communication method described above has a plurality of frame rows corresponding to different channels, and the frame rows are asynchronous in the time domain. As compared with the conventional TDD frame structure, the frame rows corresponding to different channels can allow transmission blocks of two opposite directions to be arranged in two different channels within a same time interval, so transmission latency between transmissions of the two opposite directions can be effectively reduced (equivalent to the effect of the FDD frame structure). As compared with the FDD frame structure, the frame rows that are asynchronous in the time domain can effectively reduce transmission latency between two transmissions of a same direction in some transmission mechanisms (e.g., HARQ or Scheduling Request). Therefore, as compared with the conventional communication systems, the frame structure adopted in the communication device and the communication method described above is more flexible in use and more efficient.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A communication device, comprising:
a processor, being configured to define a frame structure; and
a transceiver, being configured to perform a communication with a receiving user terminal according to the frame structure;
wherein the frame structure comprises a plurality of control blocks and a plurality of data blocks, and the control blocks and the data blocks are distributed among a plurality of channels based on scheduling periods of multiple time spans.

2. The communication device according to claim 1, wherein each of the control blocks corresponds to at least one of the data blocks.

3. The communication device according to claim 1, wherein each of the data blocks corresponds to at least one of the control blocks.

4. The communication device according to claim 1, wherein at least one control block among the control blocks that is distributed in one of the channels corresponds to at least one data block among the data blocks that is distributed in another of the channels.

5. The communication device according to claim 1, wherein the processor defines the frame structure according to Quality of Service (QoS) information provided by the receiving user terminal.

6. The communication device according to claim 1, wherein the communication device is a transmitting user terminal, each of the control blocks is a scheduling assignment pool, each of the data blocks is a data pool, and the communication is a sidelink communication.

7. The communication device according to claim 1, wherein the communication device is a base station, each of the control blocks is a physical downlink control channel (PDCCH), each of the data blocks is a physical downlink shared channel (PDSCH), and the communication is a downlink communication.

8. The communication device according to claim 1, wherein the communication device is a base station, each of the control blocks is a PDCCH, each of the data blocks is a physical uplink shared channel (PUSCH), and the communication is an uplink communication.

9. The communication device according to claim 1, wherein the communication device is a base station, the processor further defines another frame structure, the another frame structure comprises a plurality of scheduling assignment pools and a plurality of data pools, the scheduling assignment pools and the data pools are distributed among a plurality of channels based on scheduling periods of multiple time spans, and the transceiver further transmits the another frame structure to a transmitting user terminal so that the transmitting user terminal performs a sidelink communication with another receiving user terminal according to the another frame structure.

10. The communication device according to claim 9, wherein the processor defines the another frame structure according to resource availability information provided by the transmitting user terminal and Quality of Service (QoS) information provided by the another receiving user terminal.

11. A communication method, comprising:
defining a frame structure by a communication device; and
performing a communication with a receiving user terminal by the communication device according to the frame structure;
wherein the frame structure comprises a plurality of control blocks and a plurality of data blocks, and the control blocks and the data blocks are distributed among a plurality of channels based on scheduling periods of multiple time spans.

12. The communication method according to claim 11, wherein each of the control blocks corresponds to at least one of the data blocks.

13. The communication method according to claim 11, wherein each of the data blocks corresponds to at least one of the control blocks.

14. The communication method according to claim 11, wherein at least one control block among the control blocks that is distributed in one of the channels corresponds to at least one data block among the data blocks that is distributed in another of the channels.

15. The communication method according to claim 11, wherein the communication device defines the frame structure according to QoS information provided by the receiving user terminal.

16. The communication method according to claim 11, wherein the communication device is a transmitting user terminal, each of the control blocks is a scheduling assignment pool, each of the data blocks is a data pool, and the communication is a sidelink communication.

17. The communication method according to claim 11, wherein the communication device is a base station, each of the control blocks is a physical downlink control channel (PDCCH), each of the data blocks is a physical downlink shared channel (PDSCH), and the communication is a downlink communication.

18. The communication method according to claim 11, wherein the communication device is a base station, each of the control blocks is a PDCCH, each of the data blocks is a physical uplink shared channel (PUSCH), and the communication is an uplink communication.

19. The communication method according to claim 11, wherein the communication device is a base station, the communication method further comprising:
defining another frame structure by the communication device, the another frame structure comprising a plurality of scheduling assignment pools and a plurality of data pools, the scheduling assignment pools and the data pools are distributed among a plurality of channels based on scheduling periods of multiple time spans; and
transmitting the another frame structure to a transmitting user terminal by the communication device so that the transmitting user terminal performs a sidelink communication with another receiving user terminal according to the another frame structure.

20. The communication method according to claim 19, wherein the communication device defines the another frame structure according to resource availability information provided by the transmitting user terminal and QoS information provided by the another receiving user terminal.

21. A communication device, comprising:
a processor, being configured to define a frame structure; and
a transceiver, being configured to perform a communication with a receiving user terminal according to the frame structure;
wherein the frame structure comprises a plurality of frame rows, which correspond to different channels and appear asynchronous in the time domain.

22. The communication device according to claim 21, wherein the frame rows have a same distribution pattern which comprises a plurality of downlink blocks and a plurality of uplink blocks, any of the downlink blocks comprised in each of the frame rows corresponds to any of the uplink blocks comprised in another of the frame rows, and any of the uplink blocks comprised in each of the frame rows corresponds to any of the downlink blocks comprised in another of the frame rows.

23. The communication device according to claim 21, wherein the frame rows include a first frame row and a second frame row, the first frame row comprises a plurality of downlink blocks and the second frame row comprises a plurality of uplink blocks.
